(19) United States
(12) Patent Application Publication
(10) Pub. No.: US 2016/0132921 A1
(43) Pub. Date: May 12, 2016

(54) METHODS AND SYSTEMS FOR REDEEMING AND MANAGING DIGITAL COUPONS

(71) Applicant: SCANBUY, INC., New York, NY (US)

(72) Inventors: Agustin CALVO MARTINEZ, San Agustin Del Guadalix (ES); Sergio FERNANDEZ DE TEJADA, Villanueva Del Pardillo (ES)

(73) Assignee: SCANBUY, INC., New York, NY (US)

(21) Appl. No.: 14/900,676

(22) PCT Filed: Jun. 25, 2014
(86) PCT No.: PCT/US14/44040

§ 371 Date: Dec. 22, 2015

Related U.S. Application Data
(60) Provisional application No. 61/839,401, filed on Jun. 26, 2013.

(51) Int. Cl. G06Q 30/02; G06Q 20/32

(52) U.S. Cl. CPC G06Q 30/0238; G06Q 30/0239; G06Q 20/3223; G06Q 30/0236; G06Q 20/3276

(57) ABSTRACT

Systems and methods for generating, distributing, redeeming, tracking, reporting digital and/or otherwise managing digital coupons. Digital coupons digitally associated and/or linked to consumer digital identifications and/or retail checkout digital identification to facilitate management.

### TECHNICAL FIELD

The invention generally relates to systems and methods for generating, distributing, redeeming, tracking, reporting digital and/or otherwise managing digital coupons.

### BACKGROUND

Several publications are referenced in this application. The cited references describe the state of the art to which this invention pertains and are hereby incorporated by reference, particularly the systems and methods set forth in the detailed description and figures of each reference.

A Digital Coupon is an electronic presentation, that is distributed and presented without manifesting as “paper” or in other hard-copy form, and that can be exchanged for a financial discount or for loyalty points when making a purchase. Digital coupons are available through a variety of means including on websites, social media, texts, email alerts, QR codes, etc. There are an increasing number of websites and mobile applications offering digital coupons for consumers.

Moreover, there are now standards providing guidelines for managing digital coupons. For example, the following publications: the Digital Coupon Management Standard Specification, Issue 1.0, June 2012; the GS1 General Specifications Version 12, Issue 1, January-2012; and Business Requirements Analysis Document (BRAD) Digital Coupon Management, Draft 1.0, 1 Mar. 2012, hereby incorporated by reference.

### SUMMARY OF INVENTION

The present invention relates to improved methods of distributing, acquiring, redeeming, reporting, tracking and/or otherwise managing digital coupons. Embodiments of the invention include methods of managing digital coupons from the perspective of the brands or entities generating the coupons, the retailers accepting the coupons and consumers using the coupons.

The present invention can be fully compliant to GS1 Digital Couponing Management standard.

One aspect of the invention relates to methods and systems facilitating digital coupon redemption by consumers or users interested in purchasing one or more products and/or services.

Another aspect of the invention relates to methods and systems that allow any retailer, independent of the technology of the checkout systems the retailer is using or not using (e.g., 2D optical scanners such as Imager) at their point of sale, to utilize the digital coupon methods and systems according the invention. For example, preferably, the retailer does not need to add any new hardware (e.g., optical scanners or other electronic hardware) and instead merely needs to register and have a communication with an Internet or intranet-based interface to redeem digital coupons presented by consumers and report and clear the redeemed coupons.

Another aspect of the invention relates to methods and systems for providing the above-described methods and systems to consumers, retailers and brands.

The foregoing has outlined some of the aspects of the present invention. These aspects should be construed strictly as illustrative of some of the more prominent features and applications of the invention, rather than as limitations on the invention. Many other beneficial results can be obtained by modifying the embodiments within the scope of the invention. Accordingly, for other objects and a full understanding of the invention, refer to the summary of the invention, the detailed description describing the preferred embodiment in addition to the scope of the invention defined by the claims and the accompanying drawings. The unique features characteristic of this invention and operation will be understood more easily with the description and drawings. It is to be understood that the drawings are for illustration and description only and do not define the limits of the invention.

### BRIEF DESCRIPTION OF THE DRAWINGS

The above-mentioned and other features of the inventions disclosed herein are described below with reference to the drawings of the preferred embodiments. The illustrated embodiments are intended to illustrate, but not to limit the inventions. The drawings contain the following figures:

FIG. 1 is a graphical representation of the processes involved in digital coupon management according to GS1 Digital Coupon Management Standard.

FIG. 2 is a graphical representation of a digital coupon management processes according to an embodiment of the invention.

FIG. 3 is a graphical schema of the processes involved in an implementation for performing one or more methods of the present invention.

### DETAILED DESCRIPTION OF PREFERRED EMBODIMENTS

In the following description, for purposes of explanation, specific details are set forth in order to provide a thorough understanding of different aspects of the present invention. It will be evident, however, to one skilled in the art that the present invention as defined by the claims may include some or all of the features or embodiments herein described and may further include obvious modifications and equivalents of the features and concepts described herein.

The present invention relates to improved methods of distributing, redeeming, reporting, clearing and/or tracking of digital coupons.

One embodiment relates to a method or system for digital coupon redemption comprising retrieving a digital coupon for product(s) and/or service(s) to be purchased by a user after the user scans a barcode of the product/service and redeeming the digital coupon at a checkout, wherein the digital coupon is associated with the user.

Preferably, the method further comprises reporting and clearing the coupon. Preferably, reporting and clearing the coupon with the brand, brand manager, retailer and/or publisher.

Preferably, the digital coupon is managed from a digital wallet associated with the consumer or user. Preferably, the digital coupon can by synced or shared with multiple digital wallets or accounts associated with the user.

Preferably, the consumer can share or forward one or more digital coupons with other consumers (e.g., a friend or family member) and, preferably, the digital coupon is tracked when transferred to another consumers and, preferably, associated or linked to the new consumer's identification.

According to preferred embodiments, the methods and systems include allowing brands to generate digital coupons by specifying the product or service associated with the coupon, the total number of available coupons, the validity and expiry date, the target consumers for the coupon, retailers where the coupon can be redeemed and publishers that can distribute the coupon. Preferably, brands or brand managers are provided with access to a website or API to manage and track their digital coupons and preferably also create new coupons.

Preferably, once a digital coupon is generated, retailers will be notified of the digital coupons asked or requested to be redeemed at their stores. Preferably, retailers will have the option to accept the coupon “as is”, modify the coupon as appropriate (e.g., modifying which product sizes are available, exclude items on sale, etc.) or reject the coupon. If the retailer accepts the coupon, the designated brands or brand managers or publishers will distribute the coupons in paper with 2D barcodes or other codes or in mobile links or Internet links. If the consumer is at a retailer and accesses the coupons acquired by the consumer, preferably the consumer would only see the coupons accepted by said retailer, and more preferably, when scanning the product on the retailer's shelve, the consumer would see if said retailer accepts said coupon. Preferably, the method further comprises providing the consumer with nearby retail locations accepting the digital coupons not accepted by the specific retailer.

Preferably, when a consumer clicks on a link or scans the distributed paper 2D barcode, for example, the consumer will have the associated coupon automatically added to their digital coupon wallet or digital account or otherwise linked to one or more identifications of the consumer. Preferably, methods and systems of the invention provide an access or API for the consumer to manage and track the consumer's coupons (e.g., in their digital coupon wallet) from a wallet or coupon mobile application. When the consumer is ready to redeem the consumer's digital coupons, they will scan a code (e.g., 2D barcode) on display at the checkout location or point of sale. Preferably, the service will then send the consumer's digital coupons from the coupon wallet or account to the point of sale or checkout system. The relevant coupons for the retailer will then be redeemed in real time, and the digital coupon service will track the redeemed coupon as well as providing reporting and clearing for retailers.

Preferably, the consumer can sync the consumer's digital coupons with multiple digital wallets or accounts. For example, the consumer might present the consumer's coupons using a mobile phone, a tablet, laptop or other computer device and each device may include it different wallet or account so the ability so sync digital coupons between accounts and digital wallets facilitates the consumer's use and management of the digital coupons.

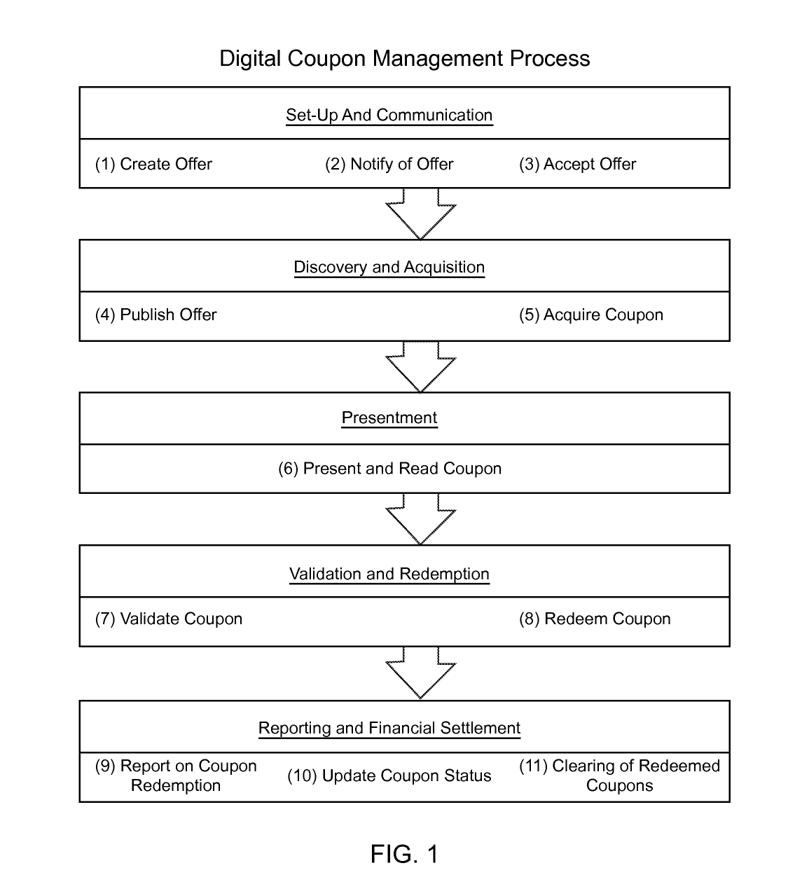

FIG. 1 shows the graphical representation of the processes for GS1 Digital Coupon Management standard from coupon creation to redemption. As shown, in the first step is “Set-Up and Communication”, the brand or brand manager creates the digital coupons and notifies retailers of the coupon and requests acceptance by retailers. Thereafter, the coupons are distributed via emails, text messages, online links, mobile links, paper coupons or the like and consumers acquire the coupons via clicking a link, downloading, scanning a QR Code or the like (“Discovery and Acquisition”). The next step (“Presentment”) includes the consumer presenting the digital coupon at a retail checkout when purchasing the products/services (alternative embodiments relate to online checkout redemption). The digital coupon is than validated and redeemed by the retailer. Thereafter, the redemption of the digital coupon can be reported to the brand or brand manager or entity issuing the coupon, the status of the digital coupon updated (for both the brand and the consumer's account or digital wallet) and the redeemed coupons cleared.

In the present invention, the digital coupon is tracked by associating the coupon with a digital identity of the consumer, preferably the identity of the mobile phone application used by the consumer to get the coupon, or two of more digital identities of the consumer. That is, when the consumer acquires the coupon, the coupon is “digitally tagged” with the consumer's identity, preferably the identity of the mobile phone application used by the consumer to get the coupon, or otherwise associated with the consumer. This allows the consumer to more easily use the coupon since associated with the consumer's identity and, according to the invention, the coupons can be synched or shared with any digital wallet or account associated with the consumer identification allowing the consumer to redeem the digital coupon regardless of the computer device being carried whether mobile phone, tablet, laptop or other device so long as having access or being linked to the consumer's identity. Moreover, during the redemption, the identity of the retail checkout location is used together with the consumer identification to send the corresponding coupons to the Point Of Sale software at said checkout location for redemption.

Accordingly, one aspect of the invention relates to methods and systems facilitating digital coupon redemption by consumers or users interested in purchasing one or more products and/or services.

One embodiment of the invention relates to a computer-based method for redeeming one or more digital coupons using a mobile device comprising:

(a) receiving a request from a user using the mobile device to retrieve a coupon for a product;

(b) determining whether one or more rules associated with the coupon for the product apply to the request;

(c) processing the request if all rules determined to be applicable are satisfied; and

(d) denying the request if one or more rules determined to be applicable are not satisfied;
wherein the processing includes:
   (i) retrieving the one or more digital coupons for the product from one or more digital coupon databases;
   (ii) storing the one or more digital coupons, wherein the one or more digital coupons are linked to a unique user identification associated with the user;
   (iii) using the mobile device at a checkout location of a retailer when the user is purchasing the product, wherein the checkout location has a unique checkout identification to facilitate redeeming the one or more digital coupons to be applied at the checkout; and
   (iv) redeeming the one or more digital coupons during the purchase of the product at the checkout using the unique user identification and the unique checkout identification.

According to alternative embodiments, one or more services are purchased with digital coupons or a combination of products and services is purchased.

Another embodiment of the invention relates to a computer-based method for a user using a mobile device to redeem one or more digital coupons comprising:
(i) transmitting a request to retrieve a coupon for a product;
(ii) retrieving the one or more digital coupons for the product from one or more digital coupon databases;
(iii) storing the one or more digital coupons, wherein the one or more digital coupons are linked to a unique user identification associated with the user;
(iv) using the mobile device at a checkout location of a retailer when the user is purchasing the product, wherein the checkout location has a unique checkout identification to facilitate redeeming the one or more digital coupons to be applied at the checkout; and
(v) redeeming the one or more digital coupons during the purchase of the product at the checkout using the unique checkout identification.

Preferably, the method includes repeating steps (i)-(iii) more than one time, more preferably, at least ten (10) times, more preferably, at least one hundred (100) times, managing multiple digital coupons that can all be redeemed at the same time.

According to one preferred embodiment, the unique user identification is derived from an application on the user's mobile device. According to one embodiment, the application is a browser application or a scanning application. According to another embodiment, the application is a browser application when the user clicks through a digital coupon link to generate the request. According to another embodiment, the application is a scanning application when the user scans an image (e.g., QR code) for a digital coupon offer to generate the request.

According to another preferred embodiment, the unique user identification is derived from the user's email/password, social login, identifications from other applications, mobile device identification, credit or debit card, or one or more loyalty cards or biometric identify (e.g., thumbprint).

According to another preferred embodiment, the retrieving of the coupon for the product is performed by the user by scanning a barcode associated with the product using the mobile device.

According to another preferred embodiment, the coupon for the product is retrieved by scanning a QR code on the product, product packaging, shelving, display and/or signage using the mobile device. Preferably, electronic displays are provided with product displays allowing the QR codes to be changes electronically via a link to the Internet or Intranet.

According to another preferred embodiment, retrieving the coupon for the product is performed by clicking an online link using the mobile device or other computer device.

According to another embodiment, the method further comprises storing the one or more digital coupons associated to the unique user identification after retrieving the one or more digital coupons for the product from the one or more digital coupon databases.

According to another embodiment, the method further comprises providing an access to one or more digital wallets associated to the unique user identification to access, display and manage the one or more digital coupons associated to the unique user identification. Preferably, the access is provided during the purchase at the checkout.

According to another embodiment, the method further comprises syncing a digital wallet containing the stored one or more digital coupons each time one or more digital coupons are retrieved.

According to another embodiment, the method further comprises syncing the digital wallet each time one or more digital coupons are redeemed.

According to another embodiment, the method further comprises wherein the one or more digital coupon databases with the coupons associated to the unique user identifications are located in one or more servers.

According to another embodiment, the method further comprises wherein the one or more coupon associated with the unique user identification are marked as expired or used, when the digital coupons expire or are redeemed. Preferably, the method comprises notifying the consumer when a digital coupon is close to expiration.

According to another embodiment, the method further comprises wherein the one or more digital coupon associated with the unique user identifications can also be associated with an additional identification (e.g., CRM identification of the brand) received from the user's mobile phone at the moment of the request for the one or more digital coupons.

According to another embodiment, the method further comprises associating a unique identification with the one or more digital coupons and transmitting the unique identification with the one or more digital coupons via a retailer API to facilitate redeeming at the checkout.

According to another embodiment, the method further comprises scanning at the checkout, using the mobile device, a QR code containing a unique identification of the checkout, to redeem the one or more digital coupons.

According to another embodiment, the method further comprises having a NFC tag at the checkout and using the user's mobile device, to tap a NFC tag containing a unique identification of the checkout, to redeem the one or more digital coupons.

According to another embodiment, the method further comprises using the retailer's loyalty card at the checkout at the retailer to redeem the one or more digital coupons, providing that the loyalty card has been previously associated to the unique user identification.

According to another embodiment, the method further comprises displaying at the checkout, using the mobile device, a QR code containing an identification of the user, so that it can be scanned by an optical scanner at the checkout to redeem the one or more digital coupons.

According to another embodiment, the method further comprises an online retail checkout process wherein after selecting online the product to be purchased, the user clicks on an option to redeem coupons and the online retail checkout displays a unique QR code corresponding to the transaction of the online purchase, so that when the user scans the QR code with his mobile device, the coupons in the digital coupons databases associated to the unique user identification of the user are sent to the online retail checkout to be applied at the online purchase transaction, if applicable.

Alternative aspects of the invention relate to redemption of digital coupons at online checkout sites. That is, rather than purchasing the product(s) and redeeming the digital coupon(s) at a “brick & mortar” retail location, the consumer does so online resulting in a redemption of the coupon(s) at an online checkout (e.g., on a website or application).

One embodiment relates to a computer-based method for a user using a computer device to redeem one or more digital coupons at an online checkout comprising:
(i) transmitting a request to retrieve a coupon for a product together with a unique identification of the user;
(ii) retrieving the one or more digital coupons for the product from one or more digital coupon databases;
(iii) storing the one or more digital coupons, wherein the one or more digital coupons are linked to the unique user identification associated with the user;
(iv) using the unique user identification at an online checkout site when the user is purchasing the product, wherein the online purchase transaction at the online checkout site has a unique transaction identification to facilitate redeeming the one or more digital coupons to be applied at the online purchase transaction; and
(v) redeeming the one or more digital coupons during the purchase of the product at the online checkout using the unique checkout identification and the unique online transaction identification.

Preferably, the method includes repeating steps (i)-(iii) more than one time, more preferably, at least ten (10) times, more preferably at least 100 times, managing multiple digital coupons that can all be redeemed at the same time.

According to preferred embodiments, the method further comprises an online retail checkout process where after selecting online the product to be purchased, the user clicks on an option to redeem coupons and the online retail checkout displays a unique QR code corresponding to the transaction of the online purchase, so that when the user scans the QR code with the user's mobile device, the coupons in the digital coupons databases associated to the unique user identification of the user are sent to the online retail checkout to be applied at the online purchase transaction if applicable.

Another aspect of the invention relates to methods and systems that allow any retailer, independent of the checkout systems the retailer is using or not using (e.g., 2D optical scanners such as Imager) at their point of sale, to utilize the digital coupon methods and systems according the invention. Currently, many retailers still use laser scanners at their point of sale which cannot scan codes from the vast majority of mobile handsets. According to preferred embodiments of the invention, the retailer's point of sale or checkout location only requires access to the Internet or an Intranet or a connection to an API. That is, according to preferred embodiments, the retailer is not required to purchase or use any special hardware to redeem the digital coupons.

One embodiment of the invention relates to a computer-based method for digital coupon management comprising:
(i) creating a unique identification of each checkout which will be used to facilitate redeeming digital coupons to be applied at the checkout;
(ii) receiving at least one unique user identification from a user at the checkout as well as the unique identification of the checkout using the user's mobile device, a loyalty card or credit card;
(iii) retrieving one or more digital coupons for the product from one or more digital coupon databases, wherein the one or more digital coupons are linked to the unique user identification associated with the user; and
(iv) redeeming the one or more digital coupons during the purchase of the product at a checkout using a unique identification associated with the checkout.

Preferably, two or more products are purchased with digital components.

Preferably, the method includes repeating steps (i)-(iii) at least ten times, more preferably, at least one hundred times, even more preferably at least one thousand times.

Preferably, the method includes repeating steps (ii)-(iv) at least ten times, more preferably, at least one hundred times, even more preferably at least one thousand times.

According to alternative embodiments, the user is purchasing one or more services instead of a product or a combination of products and services.

Another embodiment of the invention relates to computer-based method for digital coupon management comprising:

(i) scanning a product to be purchased by a user at a checkout;

(ii) receiving at least one unique user identification from the user at the checkout as well as the unique identification of the checkout using the user's mobile device, a loyalty card or credit card;

(iii) retrieving one or more digital coupons for the product from one or more digital coupon databases, wherein the one or more digital coupons are linked to the unique user identification associated with the user; and

(iv) redeeming the one or more digital coupons during the purchase of the product at a checkout using a unique identification associated with the checkout.

Preferably, the method includes repeating steps (i)-(iv) at least ten times, more preferably, at least one hundred times, even more preferably at least one thousand times.

According to alternative embodiments, the method includes an online checkout using one or more digital computers. That is, rather than a checkout site at a retail location the methods and systems relate to redeeming one or more digital coupons at an online checkout.

According to one preferred embodiment, the method further comprises an online retail checkout process wherein after selecting online the product to be purchased, the user clicks on an option to redeem coupons and the online retail checkout displays a unique QR code corresponding to the transaction of the online purchase, so that when the user scans the QR code with his mobile device, the coupons in the digital coupons databases associated to the unique user identification of the user are sent to the online retail checkout to be applied at the online purchase transaction if applicable.

Preferably, wherein the unique identification of the checkout is used together with the user loyalty card (which has been previously associated to the unique user identification) to facilitate redeeming the one or more digital coupons associated to the unique user identification to be applied at the checkout.

Another embodiment of the invention relates to a computer-based method for digital coupon management comprising:

(i) scanning a product to be purchased by a user at a checkout;

(ii) retrieving one or more digital coupons for the product from one or more digital coupon databases, wherein the one or more digital coupons are linked to a unique user identification associated with the user; and

(iii) redeeming the one or more digital coupons during the purchase of the product at a checkout using a unique identification associated with the checkout.

Another embodiment of the invention relates to a computer-based method for digital coupon management comprising:
(i) receiving a request from a user computer or mobile device to purchase a product at an online checkout;
(ii) receiving at least one unique user identification from the user at the online checkout using the user's computer device, mobile device, a loyalty card or credit card and the unique identification of the online checkout;
(iii) retrieving one or more digital coupons for the product from one or more digital coupon databases, wherein the one or more digital coupons are linked to the at least one unique user identification associated with the user; and
(iv) redeeming the one or more digital coupons during the purchase of the product at the online checkout using a unique identification associated with the checkout and/or the at least one unique user identification.

Preferably, the method includes repeating steps (i)-(iv) at least ten times, more preferably, at least one hundred times, even more preferably at least one thousand times.

Preferably, the method redeems two or more digital coupons for two or more products, more preferably, four or more digital coupons for four or more products.

Another aspect of the invention relates to methods and systems for providing the above-described methods and systems to consumers, retailers and brands.

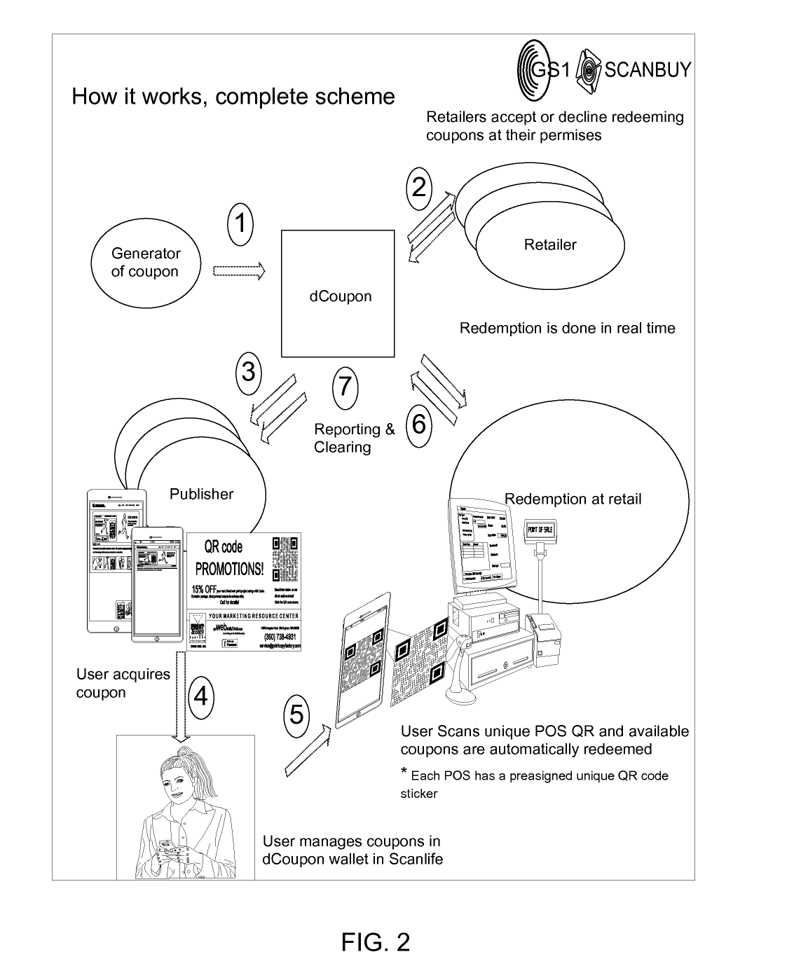

FIG. 2 is a graphical representation of a method and system of generating and managing digital coupons according to one embodiment of the invention. Step 1 involves the Generator of the coupon (e.g., brand, brand manager or other entity creating coupons for products and/or services) creating the digital coupon (“dCoupon”). After the creation of the dCoupon, it can be sent to one or more retailers or retail premises over a computer-based network (e.g., Internet, Intranet, email, wireless, etc.) and the retailers have the option to accept or decline redeeming the dCoupon at their premises or may otherwise request a modification to the dCoupon (e.g., exclude “for sale” items, limit to specific items, etc.) (Step 2). The dCoupon is also distributed to publishers (Step 3) to distribute the digital coupons via online promotions, online ads, emails, text messages, print ads or displays or other means for distributing coupons. Consumer can then acquire the coupons (and such acquired coupons digitally associated with the consumer) (Step 4) and can manage the consumer's dCoupons in a digital wallet. Thereafter, the dCoupons can be redeemed by the consumer at a retail premise (Step 5) when the consumer scans a QR Code at the checkout to obtain the checkout's “identity” and the consumer's digital coupons are then redeemed at the checkout using the checkout's identity. The redemption is preferably done in real time. Thereafter, dCoupons status is reported and cleared. Accordingly, the invention provides a seamless process for digital coupon management from start to finish preferably without requiring specific hardware that the retail location.

Advantageously, according to preferred embodiments of the invention, if a retailer declines the dCoupon in Step 2, the consumer would be notified before trying to purchase the product(s) at that retailer. For example, when the consumer scans a product's QR Code at the retail store, the system would notify the consumer the coupon could not be used at that retail location. Preferably, the system notifies the consumer of nearby retail locations that accept the coupon. Preferably, the consumer can check the coupon acceptability before heading to the store. Linking consumer identification information and retail related information to the digital coupons according to preferred embodiments of the invention provides synergies facilitating the management and use of digital coupons.

Another embodiment of the invention relates to a computer-based method for digital coupon management comprising:

receiving by a server a request from a user mobile device over a network to retrieve a coupon for a product;

determining whether one or more rules associated with digital coupons for the product apply to the request from the user mobile device;

processing the request if all rules determined to be applicable are satisfied; and

denying the request if one or more rules determined to be applicable are not satisfied;

wherein the processing includes:
(i) retrieving one or more digital coupons for the product from one or more digital coupon databases;
(ii) receiving at least one unique user identification for the user;
(iii) storing the one or more digital coupons associated with the unique user identification;
(iv) receiving the identification or any other identification associated to the user and a unique identification of the retailer's checkout where the user is purchasing the product or products with associated coupon(s);
(v) transmitting to the retailer the one or more digital coupons linked to the unique user identification, together with the checkout identification; and
(vi) redeeming the one or more digital coupons during the purchase of the product at a checkout using the unique identification associated with the checkout.

Preferably, the method includes repeating steps (i)-(iii) more than one time, more preferably, at least ten (10) times, more preferably at least 100 times, managing multiple digital coupons that can all be redeemed at the same time.

Preferably, the method redeems two or more digital coupons for two or more products, more preferably, four or more digital coupons for four or more products.

According to one preferred embodiment, the method further comprises transmitting the one or more digital coupons having the unique user identification to the checkout during the purchase allowing the one or more digital coupons to be matched with the product to apply discounts offered by the one or more digital coupons.

According to another preferred embodiment, the method further comprises (i) transmitting a request to login or register to the user if the unique user identification is unknown and (ii) registering the user creating a unique identification for the user or (iii) associating the unknown user identification to the user identified by the login information.

According to another preferred embodiment, the method further comprises receiving the unique user identification by the user scanning an image (e.g., QR code) containing a unique identification of the checkout) at the checkout.

According to another preferred embodiment, the method further comprises receiving the unique user identification by having a NFC tag at the checkout and using the user's mobile device, to tap a NFC tag containing a unique identification of the checkout.

According to another preferred embodiment, the method further comprises receiving the unique user identification at the checkout by a checkout clerk scanning an image (e.g., QR Code) on the mobile device using an optical reader, which will also transmit the unique identification of the checkout.

According to another preferred embodiment, the method further comprises receiving the unique user identification by the user using his retailer's loyalty card at the checkout at the retailer, providing that the loyalty card has been previously linked to the user identification.

According to another preferred embodiment, the method further comprises wherein the one or more digital coupons are stored and associated to the user's identification.

According to another preferred embodiment, one or more digital wallets associated to the user identification can access, display and manage the one or more digital coupons associated to the user identification.

According to another preferred embodiment, the one or more stored digital coupons are retrieved for redeeming during the purchase of the product.

According to another preferred embodiment, the method further comprises syncing the digital wallet associated to the user identification with the coupons associated to the user identification stored in the digital coupons database. Preferably, further comprising syncing the digital wallet each time one or more digital coupons are redeemed or expire.

According to another preferred embodiment, the first user can manage digital coupons associated to his user identification within one or more digital wallets associated also to his user identification, providing these wallets with access to the digital coupons database. Preferably the user can forward or share the digital coupons with other users by transmitting to other user's digital wallets or accounts.

According to another preferred embodiment, the one or more digital coupons are each managed by a corresponding brand user associated with the coupons and products via a brand management interface. Preferably, the one or more digital coupons are assigned a CRM identification relating to the user thereby allowing notifications to the brand users when the one or more digital coupons are redeemed. Preferably, the notifications are in real time.

Preferably, the brand management interface allows the brand user to generate coupons specifying: (i) the product(s) associated with the coupon, (ii) target consumer characteristics, (iii) retailers where coupons can be redeemed, (iv) publishers allowed to distribute the coupons, (v) total number of coupons, and (vi) expiration date for the coupon.

According to another preferred embodiment, the retailer is allowed to accept the one or more digital coupons, request modification of the one or more digital coupons or reject the one or more digital coupons.

According to another preferred embodiment, the method further comprises allowing users to request of the one or more digital coupons in paper with QR codes or using online links.

According to another preferred embodiment, the method further comprises an online retail checkout process wherein after selecting online the product to be purchased, the user clicks on an option to redeem coupons and the online retail checkout displays a unique QR code corresponding to the transaction of the online purchase, so that when the user scans the QR code with his mobile device, the coupons in the digital coupons databases associated to the unique user identification of the user are sent to the online retail checkout to be applied at the online purchase transaction if applicable.

Another embodiment relates to a computer-based method for digital coupon management comprising:

receiving by a server a request from a user computer or mobile device over a network to retrieve a coupon for a product, together with a unique identification for the user;

determining whether one or more rules associated with digital coupons for the product apply to the request from the user computer or mobile device;

processing the request if all rules determined to be applicable are satisfied; and

denying the request if one or more rules determined to be applicable are not satisfied;

wherein the processing includes:
(i) receiving at least one unique user identification for the user;
(ii) retrieving one or more digital coupons for the product from one or more digital coupon databases;
(iii) storing the one or more digital coupons associated with the unique user identification;
(iv) receiving the identification or any other identification associated to the user and a unique identification of an online checkout where the user is purchasing the product or products with associated coupon(s);
(v) transmitting to the online checkout the one or more digital coupons linked to the unique user identification; and
(vi) redeeming the one or more digital coupons during the purchase of the product at the online checkout using the unique identification associated with the online checkout.

Preferably, the method includes repeating steps (i)-(vi) at least ten times, more preferably, at least one hundred times, even more preferably at least one thousand times.

Another aspect of the invention relates to systems, processors, databases and other computer-based components or devices configured, adapted or designed to perform the computer-based methods of the invention.

One embodiment of the invention relates to a computer based system capable of performing any of the methods described-above comprising at least one computer device comprising a processor coupled to a memory, the memory having computer readable code, which when executed by the processor causes the computer based system to perform the method.

Another embodiment of the invention relates to a computer based electronic payment system capable of performing any of the methods described herein comprising at least one computer device comprising a processor coupled to a memory, the memory having computer readable code, which when executed by the processor causes the electronic digital coupon system to perform the method.

Preferably, the method is distributed over a network of computer devices. For example, multiple mobile computed-based devices and other computers.

Preferred embodiments of the present invention comprise storage medium with a machine-readable computer program, the computer program comprising instructions for enabling a processor to implement the method according to the present invention. According to preferred embodiments, a machine-readable program storage device stores encoded instructions for performing the methods of the invention.

FIG. 3 illustrates the components of a basic computing device in accordance with preferred embodiments of the present invention. The computing device may be a personal computer, workstation, server, or any other type of microprocessor-based device, including for example a mobile electronic device such as a PDA (personal digital assistant) or a mobile telephone or smartphone or tablet or smart watch or Google Glasses or the like. The computing device may include one or more of a processor (910), input device (920), output device (930), storage (940), and communication device (960).

The input device (920) may include a keyboard, mouse, pen-operated touch screen or monitor, voice-recognition device, or any other device that provides input. The output device (930) may include a monitor, printer, disk drive, speakers, or any other device that provides output.

The storage (940) may include volatile and nonvolatile data storage, including one or more electrical, magnetic or optical memories including such as a RAM, cache, hard drive, CD-ROM drive, tape drive or removable storage disk. The communication device (960) may include a modem, network interface card, or any other device capable of transmitting and receiving signals over a network. The components of the computing device may be connected in any manner, such as via electrical bus or wirelessly.

The software (950), which may be stored in the storage (940) and executed by the processor (910), may include, for example, the application programming that embodies the functionality of the present invention (e.g., digital coupon creation, distribution, acquisition, redeeming, tracking, reporting, etc.). The software (950) may include a combination of client applications and enterprise servers such as an application server and a database server.

Communications may occur over any type of network, which may implement any communications protocol, which may be secured by any security protocol. Network links may include telephone lines, DSL, cable networks, T1 or T3 lines, wireless network connections, or any other arrangement that implements the transmission and reception of network signals.

The computing device may implement any operating system, such as Windows, Linux or UNIX. The software (950) may be written in any programming language, such as C, C++, Java, Ruby on Rails, Visual Basic and/or SQL. In various embodiments, application software embodying the functionality of the present invention may be deployed on a standalone machine, in a client/server arrangement or through a Web browser as a Web-based application or Web service, for example.

With respect to the appended claims, unless stated otherwise, the term “first” does not, by itself, require that there also be a “second”.

While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention. As used herein and in the appended claims, a “server” should be understood to refer to one server or more than one server.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “transmitting” or “retrieving” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Thus, the present disclosure also relates to an apparatus for performing the operations described herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

1. A computer-based method for redeeming one or more digital coupons using a mobile device comprising:
(a) receiving a request from a user using said mobile device to retrieve a coupon for a product;
(b) determining whether one or more rules associated with the coupon for said product apply to the request;
(c) processing the request if all rules determined to be applicable are satisfied; and
(d) denying the request if one or more rules determined to be applicable are not satisfied;
wherein said processing includes:
(i) retrieving said one or more digital coupons for the product from one or more digital coupon databases;
(ii) storing said one or more digital coupons, wherein said one or more digital coupons are linked to a unique user identification associated with said user;
(iii) using said mobile device at a checkout location of a retailer when said user is purchasing said product, wherein said checkout location has a unique checkout identification to facilitate redeeming said one or more digital coupons to be applied at said checkout; and
(iv) redeeming said one or more digital coupons during the purchase of said product at said checkout using said unique user identification and said unique checkout identification.

2. A computer-based method for a user using a mobile device to redeem one or more digital coupons comprising:
(i) transmitting a request to retrieve a coupon for a product;
(ii) retrieving said one or more digital coupons for the product from one or more digital coupon databases;
(iii) storing said one or more digital coupons, wherein said one or more digital coupons are linked to a unique user identification associated with said user;
(iv) using said mobile device at a checkout location of a retailer when said user is purchasing said product, wherein said checkout location has a unique checkout identification to facilitate redeeming said one or more digital coupons to be applied at said checkout; and
(v) redeeming said one or more digital coupons during the purchase of said product at said checkout using said unique checkout identification.

3. The method of claim 1, wherein said unique user identification is derived from an application on said user's mobile device.

4.-6. (canceled)

7. The method of claim 1, wherein said unique user identification is derived from the user's email/password, social login, identifications from other applications, mobile device identification, credit or debit card, or one or more loyalty cards.

8. (canceled)

9. The method of claim 1, wherein said coupon for the product is retrieved by scanning a QR code on said product or adjacent said product or product display using said mobile device.

10. The method of claim 1, wherein said retrieving said coupon for the product is performed by clicking an online link using said mobile device or other computer device.

11. The method of claim 1, further comprising storing said one or more digital coupons associated to said unique user identification after retrieving said one or more digital coupons for said product from said one or more digital coupon databases.

12.-13. (canceled)

14. The method of claim 1, further comprising syncing a digital wallet containing said stored one or more digital coupons each time one or more digital coupons are retrieved.

15.-22. (canceled)

23. The method of claim 1, further comprising displaying at said checkout, using said mobile device, a QR code containing an identification of said user, so that it can be scanned by an optical scanner at the checkout to redeem said one or more digital coupons.

24. (canceled)

25. A computer-based method for a user using a computer device to redeem one or more digital coupons at an online checkout comprising:
(i) transmitting a request to retrieve a coupon for a product together with a unique identification of said user;
(ii) retrieving said one or more digital coupons for the product from one or more digital coupon databases;
(iii) storing said one or more digital coupons, wherein said one or more digital coupons are linked to the unique user identification associated with said user;
(iv) using said unique user identification at an online checkout site when said user is purchasing said product, wherein said online purchase transaction at said online checkout site has a unique transaction identification to facilitate redeeming said one or more digital coupons to be applied at said online purchase transaction; and
(iv) redeeming said one or more digital coupons during the purchase of said product at said online checkout using said unique checkout identification and said unique online transaction identification.

26. The method of claim 25, further comprising an online retail checkout process where after selecting online the product to be purchased, said user clicks on an option to redeem coupons and the online retail checkout displays a unique QR code corresponding to the transaction of the online purchase, so that when said user scans said QR code with the user's mobile device, the coupons in the digital coupons databases associated to the unique user identification of said user are sent to the online retail checkout to be applied at said online purchase transaction if applicable.

27. A computer-based method for digital coupon management comprising:
receiving by a server a request from a user mobile device over a network to retrieve a coupon for a product;
determining whether one or more rules associated with digital coupons for said product apply to the request from the user mobile device;
processing the request if all rules determined to be applicable are satisfied; and
denying the request if one or more rules determined to be applicable are not satisfied;
wherein said processing includes:
(i) retrieving one or more digital coupons for said product from one or more digital coupon databases;
(ii) receiving at least one unique user identification for said user;
(iii) storing said one or more digital coupons associated with said unique user identification;
(iv) receiving said identification or any other identification associated to said user and a unique identification of the retailer's checkout where the user is purchasing the product or products with associated coupon(s);
(v) transmitting to said retailer said one or more digital coupons linked to said unique user identification, together with the checkout identification; and
(vi) redeeming said one or more digital coupons during the purchase of said product at a checkout using the unique identification associated with said checkout.

28.-45. (canceled)

46. The method of claim 27, further comprising an online retail checkout process where after selecting online the product to be purchased, said user clicks on an option to redeem coupons and the online retail checkout displays a unique QR code corresponding to the transaction of the online purchase, so that when said user scans said QR code with his mobile device, the coupons in the digital coupons databases associated to the unique user identification of said user are sent to the online retail checkout to be applied at said online purchase transaction if applicable.

47. A computer-based method for digital coupon management comprising:
receiving by a server a request from a user computer or mobile device over a network to retrieve a coupon for a product, together with a unique identification for said user;
determining whether one or more rules associated with digital coupons for said product apply to the request from the user computer or mobile device;
processing the request if all rules determined to be applicable are satisfied; and
denying the request if one or more rules determined to be applicable are not satisfied;
wherein said processing includes:
(i) receiving at least one unique user identification for said user;
(ii) retrieving one or more digital coupons for said product from one or more digital coupon databases;
(iii) storing said one or more digital coupons associated with said unique user identification;
(iv) receiving said identification or any other identification associated to said user and a unique identification of an online checkout where the user is purchasing the product or products with associated coupon(s);
(v) transmitting to said online checkout said one or more digital coupons linked to said unique user identification; and
(vi) redeeming said one or more digital coupons during the purchase of said product at said online checkout using the unique identification associated with said online checkout.

48. A computer-based method for digital coupon management comprising:
(i) creating a unique identification of each checkout which will be used to facilitate redeeming digital coupons to be applied at said checkout;
(ii) receiving at least one unique user identification from said user at said checkout as well as the unique identification of the checkout using said user's mobile device, a loyalty card or credit card;
(iii) retrieving one or more digital coupons for said product from one or more digital coupon databases, wherein said one or more digital coupons are linked to said unique user identification associated with said user; and
(iv) redeeming said one or more digital coupons during the purchase of said product at a checkout using a unique identification associated with said checkout.

49. A computer-based method for digital coupon management comprising:
(i) scanning a product to be purchased by a user at a checkout;
(ii) receiving at least one unique user identification from said user at said checkout as well as the unique identification of the checkout using said user's mobile device, a loyalty card or credit card;
(iii) retrieving one or more digital coupons for said product from one or more digital coupon databases, wherein said one or more digital coupons are linked to said unique user identification associated with said user; and
(iv) redeeming said one or more digital coupons during the purchase of said product at a checkout using a unique identification associated with said checkout.

50. The method of claim 48, further comprising an online retail checkout process where after selecting online the product to be purchased, said user clicks on an option to redeem coupons and the online retail checkout displays a unique QR code corresponding to the transaction of the online purchase, so that when said user scans said QR code with his mobile device, the coupons in the digital coupons databases associated to the unique user identification of said user are sent to the online retail checkout to be applied at said online purchase transaction if applicable.

51. (canceled)

52. A computer-based method for digital coupon management comprising:
(i) scanning a product to be purchased by a user at a checkout;
(ii) retrieving one or more digital coupons for said product from one or more digital coupon databases, wherein said one or more digital coupons are linked to a unique user identification associated with said user; and
(iii) redeeming said one or more digital coupons during the purchase of said product at a checkout using a unique identification associated with said checkout.

53. A computer-based method for digital coupon management comprising:
(i) receiving a request from a user computer or mobile device to purchase a product at an online checkout;
(ii) receiving at least one unique user identification from said user at said online checkout using said user's computer device, mobile device, a loyalty card or credit card and the unique identification of the online checkout;
(iii) retrieving one or more digital coupons for said product from one or more digital coupon databases, wherein said one or more digital coupons are linked to said at least one unique user identification associated with said user; and
(iv) redeeming said one or more digital coupons during the purchase of said product at said online checkout using a unique identification associated with said checkout and/or said at least one unique user identification.

54. A method for digital coupon redeeming comprising retrieving a digital coupon for a product to be purchased by a user after said user scans a barcode of the product and redeeming said digital coupon at a checkout, wherein said digital coupon is associated with said user.

55.-56. (canceled)
